(19) United States
(12) Patent Application Publication
(10) Pub. No.: US 2024/0172006 A1
(43) Pub. Date: May 23, 2024

(54) METHOD AND APPARATUS FOR BEAM RECOVERY, COMMUNICATION DEVICE AND STORAGE MEDIUM

(71) Applicants: BEIJING XIAOMI MOBILE SOFTWARE CO., LTD., Beijing (CN); BEIJING UNIVERSITY OF POSTS AND TELECOMMUNICATIONS, Beijing (CN)

(72) Inventors: Yajun ZHU, Beijing (CN); Wei HONG, Beijing (CN); Junli LI, Beijing (CN); Yong LI, Beijing (CN)

(73) Assignees: BEIJING XIAOMI MOBILE SOFTWARE CO., LTD., Beijing (CN); BEIJING UNIVERSITY OF POSTS AND TELECOMMUNICATIONS, Beijing (CN)

(21) Appl. No.: 18/280,226

(22) PCT Filed: Mar. 4, 2021
(86) PCT No.: PCT/CN2021/079160

§ 371 Date: Sep. 3, 2023

(51) Int. Cl. H04W 24/04; H04B 7/06

(52) U.S. Cl. CPC H04W 24/04; H04B 7/0696

(57) ABSTRACT

A method for beam recovery is provided, the method is performed by a terminal and includes: determining, according to a reference signal (RS) detection result for beam failure detection (BFD) on a monitoring occasion within an active time window, an operation for the beam recovery; where the active time window comprises the monitoring occasion with a variable quantity; and before the beam recovery or before a beam pre-recovery process is initiated, a quantity of the monitoring occasions within the active time window is increased according to a RS detection result for each BFD.

### CROSS-REFERENCE

The present application is a U.S. National Stage of International Application No. PCT/CN2021/079160, filed on Mar. 4, 2021, the entire disclosure of which is incorporated herein by reference for all purposes.

### TECHNICAL FIELD

The present disclosure relates to, but is not limited to, a field of wireless communication technology, and more particularly to a method and an apparatus for beam recovery, a communication device and a storage medium.

### BACKGROUND

Increasing mobile devices and booming mobile Internet have brought about exploding mobile data, which lead to higher requirements for a traffic density, a network capacity, a user rate, a time delay, and the like. In order to tackle the challenge, the 5th-Generation (5G) mobile communication new radio (NR) has been a new radio designed for new scenarios and new frequency bands. High-frequency millimeter wave communication is an important research direction for 5G. Compared with data transmission in low-frequency bands, millimeter wave faces its unique challenge. For example, communication is easily interrupted when a data transmission channel is blocked.

### SUMMARY

Embodiments of the present disclosure provide a method and an apparatus for beam recovery, a communication device and a non-transitory storage medium.

According to a first aspect of the present embodiments, the method for beam recovery is provided, applied to a terminal, and the method includes:
determining, according to a reference signal RS detection result for beam failure detection BFD on a monitoring occasion within an active time window, an operation for the beam recovery;
where the active time window includes the monitoring occasion with a variable quantity; and before the beam recovery or before a beam pre-recovery process is initiated, a quantity of the monitoring occasions within the active time window is increased according to a RS detection result for each detection.

According to a second aspect of the present embodiments, the method for beam recovery is provided, applied to a base station, and the method includes:
sending a BFD RS;
where the BFD RS is used for a terminal: to determine an operation for the beam recovery according to a RS detection result for beam failure detection BFD on a monitoring occasion within an active time window;
where the active time window includes the monitoring occasion with a variable quantity;
and before the beam recovery or before a beam pre-recovery process is initiated, a quantity of the monitoring occasions within the active time window is increased according to a RS detection result for each detection.

According to a third aspect of the present embodiments, a communication device is provided and includes:
a processor; and
a memory for storing executable instructions of the processor,
where the processor is configured to implement the method according to any embodiment of the present disclosure when running the executable instructions.

### BRIEF DESCRIPTION OF THE DRAWINGS

FIG. 1 is a schematic diagram of a structure of a wireless communication system.

FIG. 2A is a schematic diagram illustrating a beam recovery process according to an embodiment.

FIG. 2B is a schematic diagram illustrating a beam recovery process according to an embodiment.

FIG. 3 is a schematic diagram illustrating a beam recovery process according to an embodiment.

FIG. 4 is a schematic diagram illustrating a beam recovery process according to an embodiment.

FIG. 5 is a flowchart illustrating a method for beam recovery according to an exemplary embodiment.

FIG. 6 is a flowchart illustrating a method for beam recovery according to an embodiment.

FIG. 7 is a schematic diagram illustrating a beam recovery process according to an embodiment.

FIG. 8 is a schematic diagram illustrating a beam recovery process according to an embodiment.

FIG. 9 is a flowchart illustrating a method for beam recovery according to an embodiment.

FIG. 10 is a flowchart illustrating a method for beam recovery according to an embodiment.

FIG. 11 is a flowchart illustrating a method for beam recovery according to an embodiment.

FIG. 12 is a flowchart illustrating a method for beam recovery according to an embodiment.

FIG. 13 is a flowchart illustrating a method for beam recovery according to an embodiment.

FIG. 14 is a flowchart illustrating a method for beam recovery according to an embodiment.

FIG. 15 is a flowchart illustrating a method for beam recovery according to an embodiment.

FIG. 16 is a flowchart illustrating a method for beam recovery according to an embodiment.

FIG. 17 is a flowchart illustrating a method for beam recovery according to an embodiment.

FIG. 18 is a flowchart illustrating a method for beam recovery according to an embodiment.

FIG. 19 is a flowchart illustrating a method for beam recovery according to an exemplary embodiment.

FIG. 20 is a flowchart illustrating a method for beam recovery according to an embodiment.

FIG. 21 is a flowchart illustrating a method for beam recovery according to an embodiment.

FIG. 22 is a flowchart illustrating a method for beam recovery according to an exemplary embodiment.

FIG. 23 is a flowchart illustrating a method for beam recovery according to an embodiment.

FIG. 24 is a flowchart illustrating a method for beam recovery according to an embodiment.

FIG. 25 is a flowchart illustrating a method for beam recovery according to an embodiment.

FIG. 26 is a schematic diagram illustrating an apparatus for beam recovery according to an embodiment.

FIG. 27 is a schematic diagram illustrating an apparatus for beam recovery according to an embodiment.

FIG. 28 is a schematic diagram illustrating a structure of a terminal according to an embodiment.

FIG. 29 is a block diagram illustrating a base station according to an embodiment.

### DETAILED DESCRIPTION

Embodiments will be described in detail here, and their examples are shown in the accompanying drawings. When the following description refers to the drawings, unless otherwise indicated, the same number in different drawings indicates the same or similar elements. The implementations described in the following embodiments do not represent all implementations consistent with the embodiments of the present disclosure. On the contrary, they are only examples of apparatus and methods consistent with some aspects of the embodiments of the disclosure as detailed in the appended claims.

The terms used in the embodiments of the present disclosure are only for the purpose of describing specific embodiments, and are not intended to limit the present disclosure. The singular forms of “one”, “said” and “the” used in the present disclosure and the appended claims are also intended to include the plural form, unless the context clearly indicates other meanings. It should also be understood that the terms “and/or” as used herein refer to and include any or all possible combinations of one or more associated listed items.

It should be understood that although the terms first, second, third, etc. may be used to describe various information in the present disclosure, such information should not be limited to these terms. These terms are only used to distinguish the same type of information from each other. For example, without departing from the scope of the present disclosure, the first information may also be called the second information, and similarly, the second information may also be called the first information. Depending on the context, the word “if’ as used here may be interpreted as “when” or “while” or “in response to determining”.

For the purpose of brevity and easy understanding, the terms used herein when characterizing a size relationship are “greater than” or “less than”. However, for those skilled in the art, it may be understood that the term “greater than” also covers the meaning of “greater than or equal to”, and “less than” also covers the meaning of “less than or equal to”.

In some scenarios of a new radio system, due to the change of environment, an originally established beam pair is suddenly blocked, and a network and a terminal do not have enough time to adjust the beam. In order to quickly complete the reconstruction of the beam pair in an authorized frequency band, the beam failure recovery process is introduced for this scenario.

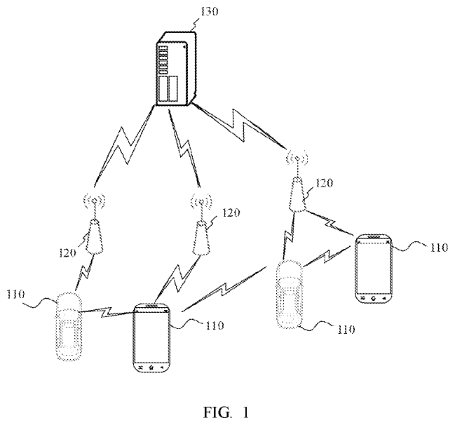

As illustrated in FIG. 1, it illustrates a block diagram of a wireless communication system provided by an embodiment of the present disclosure. As illustrated in FIG. 1, the wireless communication system is a communication system based on mobile communication technology. The wireless communication system may include several user equipment 110 and several base stations 120.

The user equipment 110 may refer to a device that provides voice and/or data connectivity to a user. The user equipment 110 may communicate with one or more core networks through a radio access network (RAN). The user equipment 110 may be an Internet-of-Things device, such as a sensor device, a mobile phone and a computer with Internet-of-Things device, such as fixed, portable, pocket, handheld, computer built-in or vehicle-mounted devices, for example, a station (STA), a subscriber unit, a subscriber station, a mobile station, a mobile, a remote station, an access point, a remote terminal, an access terminal, a user terminal, a user agent, a user device, or a user equipment (UE). Alternatively, the user equipment 110 may also be the equipment of an unmanned aerial vehicle. Alternatively, the user equipment 110 may also be an on-board device, for example, a trip computer with wireless communication function, or a wireless communication device connected to an external trip computer. Alternatively, the user equipment 110 may also be a roadside device, for example, a streetlamp, a signal lamp or other roadside devices with wireless communication functions.

The base station 120 may be a network side device in the wireless communication system. The wireless communication system may be the 4th generation mobile communication (4G) system, also known as Long Term Evolution (LTE) system. Alternatively, the wireless communication system may also be the 5th generation mobile communication (5G) system, also known as a new radio (NR) system or a 5G NR system. Alternatively, the wireless communication system may also be a next generation system of the 5G system. The access network in the 5G system may be called NG-RAN (new generation radio access network).

The base station 120 may be an evolutionary base station (eNB) used in the 4G system. Alternatively, the base station 120 may also be base station (gNB) adopting a centralized and distributed architecture in the 5G system. When the base station 120 adopts the centralized and distributed architecture, it usually includes a central unit (CU) and at least two distributed units (DU). The central unit is equipped with protocol stacks of a Packet Data Convergence Protocol (PDCP) layer, a Radio Link Control (RLC) layer and a Media Access Control (MAC) layer. The distribution unit is provided with a physical (PHY) layer protocol stack. The embodiments of the present disclosure do not limit the specific implementation mode of the base station 120.

A wireless connection may be established between the base station 120 and the user equipment 110 through a wireless radio. In different embodiments, the wireless radio is a wireless radio based on the fourth generation mobile communication network technology (4G) standard. Alternatively, the wireless radio is a wireless radio based on the fifth generation mobile communication network technology (5G) standard. For example, the wireless radio is a new radio. Alternatively, the wireless radio may also be a wireless radio based on a standard of the next generation mobile communication network technical of 5G.

In some embodiments, an E2E (End to End) connection may also be established between the user equipment 110, such as V2V (vehicle to vehicle) communication, V2I (vehicle to infrastructure) communication and V2P (vehicle to pedestrian) communication in vehicle to everything (V2X) communication.

The above user equipment may be considered as a terminal device in the following embodiments.

In some embodiments, the wireless communication system described above may also include a network management device 130.

Several base stations 120 are connected to the network management device 130 respectively. The network management device 130 may be a core network device in the wireless communication system. For example, the network management device 130 may be a mobility management entity (MME) in an evolved packet core (EPC). Alternatively, the network management device may also be other core network devices, such as a service gateway (SGW), a public data network gateway (PGW), a policy and charging rules function (PCRF) or a home subscriber server (HSS). The embodiments of the present disclosure do not limit the implementation form of the network management device 130.

In order to facilitate the understanding of those skilled in the art, the embodiments of the present disclosure list a plurality of embodiments to clearly illustrate technical solutions of the embodiments of the present disclosure. Of course, those skilled in the art may understand that the plurality of embodiments provided in the embodiments of the present disclosure may be performed separately or in combination with the method of other embodiment in the embodiments of the present disclosure, and may also be performed separately or in combination with some other method in related art, which is not limited by the embodiments of the present disclosure.

In order to better understand the technical solution described in any embodiment of the present disclosure, first, relevant application scenarios of beam recovery are illustrated:

in an embodiment, a beam failure recovery process is introduced in both a primary cell and a secondary cell, and a beam quality of the physical downlink control channel (PDCCH) may be monitored by a periodic reference signal (RS) configured for beam failure detection (BFD). The periodic RS and the PDCCH have the same transmission configuration indication (TCI) state identifier. The BFD process determines whether all monitored beams fail based on the periodic BFD RS.

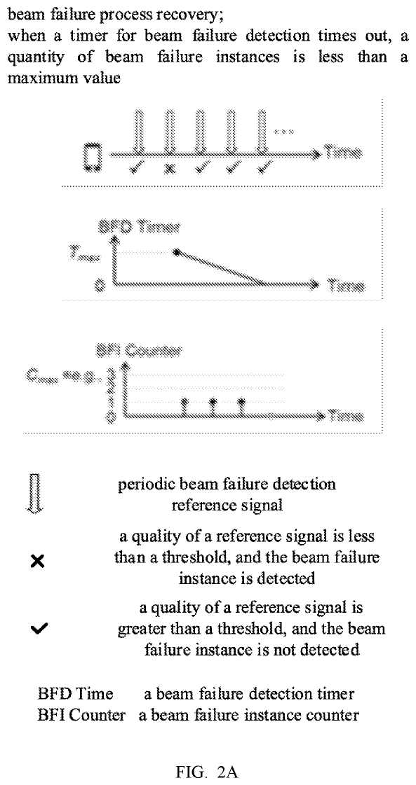

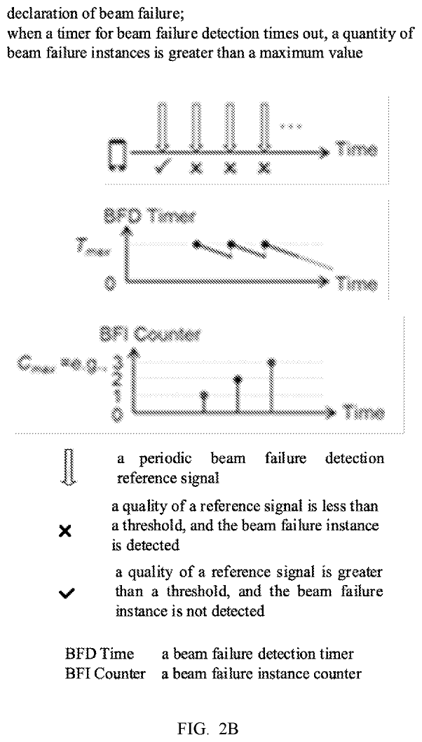

In an embodiment, referring to FIGS. 2A and 2B, a beam failure instance counter is used for counting beam failure instances. A maximum count value of the beam failure instance counter is x (for example, x=3), i.e., referring to FIG. 2A, when x beam states are consecutively detected above a threshold, beam recovery is indicated; referring to FIG. 2B, when x beam failure instances are consecutively detected, beam failure is indicated.

In an embodiment, in FIG. 2A, when a first beam failure instance is detected, a BFD timer is started, and the beam failure recovery is declared when RS qualities of x consecutive beams is detected to be better than a threshold before the BFD timer expires. In FIG. 2B, when the first beam failure instance is detected, a BFD timer is started, and the beam failure is declared when three consecutive beam failure instances are detected during the BFD is timed.

In the related art, the shortage of spectrum resources is a more and more serious reality faced by mobile communication networks. Licensed frequency bands, especially high-value low-frequency-band resources, not only are limited in bandwidth, but also are being rapidly consumed by ever growing user groups In order to meet the challenge of spectrum shortage and increase system capacity, a research plan for an NR-based unlicensed frequency band (New Radio Based Unlicensed Access, NR-U) was proposed. Although the unlicensed frequency band is rich in resource, in order to ensure fair coexistence between different Radio Access Technologies (RATs) using the frequency band, a Listen Before Talk (LBT) technology based on Clear Channel Assessment (CCA) is introduced in Licensed Assisted Access (LAA), and the introduction of LBT into NR-U is an important way to ensure fair coexistence. However, since the sending end needs to perform channel idle detection before the transmission, the channel may be occupied after the LBT is successful. Thus, when the beam failure detection is performed, there may be an increase in transmission uncertainty of the BFD RS due to the LBT mechanism, resulting in the quality of the BFD RS used for terminal evaluation not reflecting the true beam state.

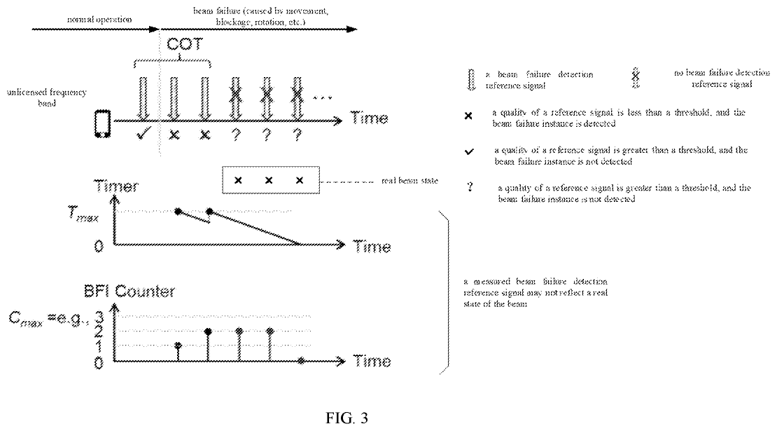

Referring to FIG. 3, when the LBT is successful, the BFD RS is transmitted within a channel occupy time (COT). However, if the LBT fails, a base station cannot transmit the BFD RS to a terminal, and the terminal cannot measure the BFD RS outside of the COT. In this case, even if the terminal is configured with the periodic BFD RS, the quantity of the BFD RS within the COT is not sufficient to evaluate and control the quality of the beam.

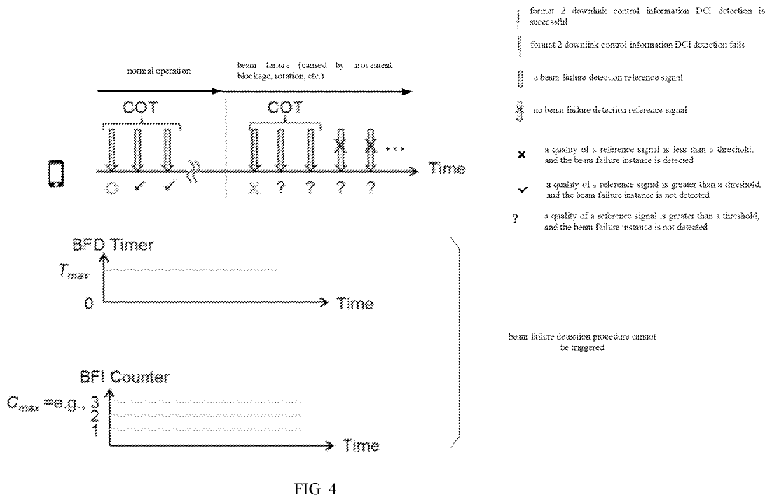

In an embodiment, as illustrated in FIG. 4, during the beam failure detection, if a beam failure occurs before the terminal receives downlink control information (DCI) format 2_0 with COT indication information, the terminal cannot perform the BFD RS measurement. In this case, the terminal cannot ensure that the BFD RS is sent within the COT, and therefore, the beam failure detection cannot be triggered. Thus, in the NR-U system, in order to reflect the real beam state and achieve the fast beam recovery, it is necessary to study the beam failure detection and recovery mechanism during uncertain BFD RS transmission in the unlicensed frequency band.

As illustrated in FIG. 5, the present embodiment provides a method for beam recovery, applied to a terminal and includes step 51:
in step 51: an operation for the beam recovery is determined according to a RS detection result for beam failure detection BFD on a monitoring occasion within an active time window;
where the active time window includes the monitoring occasion with a variable quantity; and before the beam recovery or before a beam pre-recovery process is initiated, a quantity of the monitoring occasions within the active time window is increased according to a RS detection result for each BFD.

Here, the terminal may be, but is not limited to, a mobile phone, a wearable device, a vehicle terminal, a road side unit (RSU), a smart home terminal and an industrial sensing device and the like.

In an embodiment, a beam may be a beam pair for data transmission between the terminal and the base station. Here, the beam pair includes: a receiving beam for the terminal to receive data and a sending beam for the base station to send the beam.

Here, the base station may be an access device for the terminal to access a network. The base station may be various types of base stations, such as a base station of the third-generation mobile communication (3G) network, a base station of the fourth-generation mobile communication (4G) network, a base station of the fifth-generation mobile communication (5G) network, or a base station of any generation communication system.

In an embodiment, the beam may be a downlink beam. Here, beam failure detection may be downlink beam failure detection. The beam recovery may be downlink beam recovery. In an embodiment, the beam recovery includes a process to perform beam access by using an available beam.

In an embodiment, in response to determining beam failure according to the RS detection result for the beam failure detection BFD on the monitoring occasion within the active time window, and if the terminal has an available beam to replace a current beam, the terminal may perform the beam access based on the available beam. If the access is successful by using the available beam, the available beam may be used to perform the data transmission between the terminal and the base station.

In some embodiments, the beam failure may occur in response to terminal movement; or, in response to network blockage, the beam failure may occur; or, in response to terminal rotation, the beam failure may occur.

In an embodiment, the active time window includes a plurality of monitoring occasions. On each monitoring occasion, the terminal performs a BFD RS detection to acquire the RS detection result for the BFD. Here, the RS detection result for the BFD may indicate a result of the beam failure.

In an embodiment, an initial quantity of the monitoring occasions included in the active time window is preset. For example, the preset active time window includes three monitoring occasions. Here, configuration information indicating the initial quantity may be received in advance from the base station.

In an embodiment, it is determined whether to increase the quantity of the monitoring occasions included in the active time window according to the RS detection result on the monitoring occasion within the active time window.

In an embodiment, in response to the quantity of the beam failure instances corresponding to the RS detection result on the monitoring occasion within the active time window being less than the quantity of the beam failure instances required to be detected for determining whether the beam fails, it is determined to increase the quantity of the monitoring occasions included in the active time window. Here, since the beam failure instances are not sufficient to determine whether the beam fails, it is necessary to continue increasing the quantity of the monitoring occasions included in the active time window and continue the BFD RS detection, so as to reduce a case of not being able to determine whether the beam fails due to insufficient quantity of the beam failure instances. In response to the quantity of the beam failure instances corresponding to the RS detection result on the monitoring occasion within the active time window being greater than or equal to the quantity of the beam failure instances required to be detected for determining whether the beam fails, it is determined not to increase the quantity of the monitoring occasions included in the active window. Here, since the beam failure instances are sufficient to determine whether the beam fails, there is no requirement to continue increasing the quantity of the monitoring occasions included in the active time window.

In an embodiment, the quantity of the beam failure instances required to be detected for determining whether the beam is in a beam failure state is n, and in response to the quantity of the monitoring occasions within the active time window being less than n, the quantity of the monitoring occasions included in the active time window may be increased; or the quantity of the beam failure instances required to be detected for determining whether the beam fails is n, and in response to the quantity of the beam failure instances detected on the monitoring occasion within the active time window is less than n, the quantity of the monitoring occasions included in the active time window may be increased.

In an embodiment, according to the beam recovery result, it is determined whether to increase the quantity of the monitoring occasions included in the active time window.

In an embodiment, in response to the beam recovery, it is determined not to increase the quantity of the monitoring occasions included in the active time window; in response to the beam being not recovered, it is determined to increase the quantity of the monitoring occasions included in the active time window.

In an embodiment, it is determined whether to increase the quantity of the monitoring occasions included in the active time window according to the initiation of a beam pre-recovery process.

In an embodiment, in response to the beam being not recovered and the beam pre-recovery process not being initiated, the quantity of the monitoring occasions included in the active time window is increased. In response to the beam pre-recovery process being initiated, the quantity of the monitoring occasions included in the active time window is increased until the beam is recovered.

In an embodiment, when the communication is performed by using the unlicensed frequency band, the active time window may correspond to a period of channel occupy time, and the beam failure instance counter is used to count the quantity of the beam failures during this period of channel occupy time. According to a count result of the beam failure instance counter within a preset time, it is determined whether the beam recovery is required. Here, one beam failure instance corresponds to one beam failure result.

In an embodiment, when the communication is performed by using the unlicensed frequency band, the active time window may also correspond to a period of non-channel occupy time, and the beam failure instance counter is used to count the quantity of the beam failures during this period of non-channel occupy time. According to a count result of the beam failure instance counter within a preset time, it is determined whether the beam recovery is required. Here, one beam failure instance corresponds to one beam failure result. Here, the non-channel occupy time may be a time that does not overlap or partially overlaps with the channel occupy time.

Here, it is determined whether the beam is in a beam failure state according to the RS detection result for the BFD.

In an embodiment, in response to a count value of a beam failure instance counter being greater than a count threshold within a preset time, the beam is in a beam failure state, it is determined that the beam recovery is required. In response to a count value of a beam failure instance counter being less than a count threshold within the preset time, there is no beam failure, it is determined that beam recovery is not required. For example, if the preset time is 3 seconds and the count threshold is 3, when the count value of the beam failure instance counter reaches 3 within 3 seconds, it is determined that beam recovery is required; when the count value of the beam failure instance counter is less than 3 within 3 seconds, it is determined that beam recovery is not required. In an embodiment, the count value of the beam failure instance counter within the preset time is a count value that counts consecutively.

In an embodiment, in response to that the beam recovery is required, the operation for the beam recovery may be to initiate the beam pre-recovery process. Here, the beam pre-recovery process may include at least one of the following: determining an available beam pair; sending a beam recovery request; receiving a response message sent by the base station according to the beam recovery request.

In an embodiment, in response to the beam recovery is required, a currently used beam may be switched to another available beam. For example, the currently used beam is a beam A, since a quality of the beam A is less than a quality threshold, the beam recovery is required, and the beam A may be switched to any of the available beams B, C, and D.

In an embodiment, in response to the beam recovery is required, the beam pre-recovery process is initiated; in response to determining the beam recovery based on the detected RS detection result for the BFD on the monitoring occasions with a set quantity after the beam pre-recovery process is initiated, there is no requirement to initiate the beam recovery process. For example, the quantity is set to 3, in response to the beam recovery is required, the beam pre-recovery process is initiated; in response to determining the beam recovery based on the detected RS detection result for the BFD on three monitoring occasions after the beam pre-recovery process is initiated, there is no requirement to initiate the beam recovery process. In an embodiment, in response to the beam recovery is required, the beam pre-recovery process is initiated; in response to determining the beam failure again based on the detected RS detection result for the BFD on the monitoring occasions with a set quantity after the beam pre-recovery process is initiated, the beam recovery process is required to be initiated. For example, the quantity is set to 3, in response to the beam recovery is required, the beam pre-recovery process is initiated, in response to determining the beam failure based on the detected RS detection result for the BFD on three monitoring occasions after the beam pre-recovery process is initiated, the beam recovery process is required to be initiated.

In an embodiment, the beam recovery process may be a beam recovery process performed based on a result of the beam pre-recovery process. For example, the beam recovery process may be a beam recovery process performed based on an available beam determined by the beam pre-recovery process. Thus, since the beam pre-recovery process is performed in advance of the beam recovery, the beam recovery may be performed quickly when the beam recovery is required, which may improve resource utilization efficiency.

In the embodiment of the present disclosure, the operation for the beam recovery is determined according to the RS detection result for the BFD on the monitoring occasion within the active time window. Here, since the active time window includes the monitoring occasion with a variable quantity; before the beam recovery or before the beam pre-recovery process is initiated, a quantity of the monitoring occasions within the active time window may be increased according to the RS detection result for each detection. The BFD is performed on the monitoring occasion within the active time window, compared to a case in which the RS detection result for the BFD cannot be determined outside a range of the channel occupy time or a case in which the RS detection result for the BFD cannot be determined before relevant information about the channel occupy time is received, this solution may accurately acquire the RS detection result for the BFD based on the monitoring occasion within the active time window, so as to perform the operation for the beam recovery.

It should be noted that those skilled in the art may understand that the methods provided in the embodiments of the present disclosure may be performed separately or together with some methods in the embodiments of the present disclosure or the related art.

As illustrated in FIG. 6, the present embodiment provides a method for beam recovery, applied to a terminal and includes step 61:
in step 61: in response to the RS detection result indicating that a quantity of beam failure instances BFIs is greater than a first quantity threshold, the beam pre-recovery process is initiated;
and/or,
in response to the RS detection result indicating that a quantity of beam failure instances BFIs is greater than a second quantity threshold, beam pair switching is performed; where the second quantity threshold is greater than the first quantity threshold.

In an embodiment, the first quantity threshold and/or the second quantity threshold are pre-configured.

In an embodiment, configuration information indicating the first quantity threshold and/or the second quantity threshold is received from the base station.

In an embodiment, the beam pre-recovery process may include at least one of the following: determining an available beam pair; sending a beam recovery request; receiving a response message sent by the base station according to the beam recovery request. The beam recovery request may carry information indicating the available beam pair.

In an embodiment, the quantity of the BFIs indicated by the RS detection result is a quantity of the BFIs indicated by the RS detection result within the active time window.

In an embodiment, as illustrated in FIG. 7, an initial value of the quantity of the monitoring occasions included in the active time window is 3. The first quantity threshold is a threshold value 1 (for example, the value is taken as 2); a RS detection result of a first BFD is that no BFI is detected; a RS detection result of a second BFD is that the BFI is detected; a RS detection result of a third BFD is that the BFI is detected, the quantity of the monitoring occasions included in the current active time window is less than the quantity of the beam failure instances required to be detected for determining whether the beam is in a beam failure state, and the quantity of the monitoring occasions included in the active time window is increased, for example, by adding a fourth monitoring occasion. During the fourth detection, the LBT failed, and a RS detection result of the fourth BFD is that the BFI is detected. Thus, since the quantity of the BFIs indicated by the RS detection results of the BFD is greater than the first quantity threshold, the terminal initiates the beam pre-recovery process.

In an embodiment, referring to FIG. 7, the second quantity threshold is a threshold value 2 (for example, the value is taken as 6). After the terminal initiates the beam pre-recovery process, the quantity of the monitoring occasions included in the active time window is continuously increased. Each RS detection result of a fifth BFD, a sixth BFD and a seventh BFD is that the BFI is detected. Thus, since the quantity of the BFIs indicated by the RS detection results of the BFD is greater than the second quantity threshold, the terminal performs the beam recovery process, i.e., perform the beam pair switching.

In an embodiment, the beam pre-recovery process may include at least one of the following: selecting a beam pair; sending a request for beam recovery to the base station, and performing the beam pair switching. Here, the request for the beam recovery may carry information about a selected beam pair.

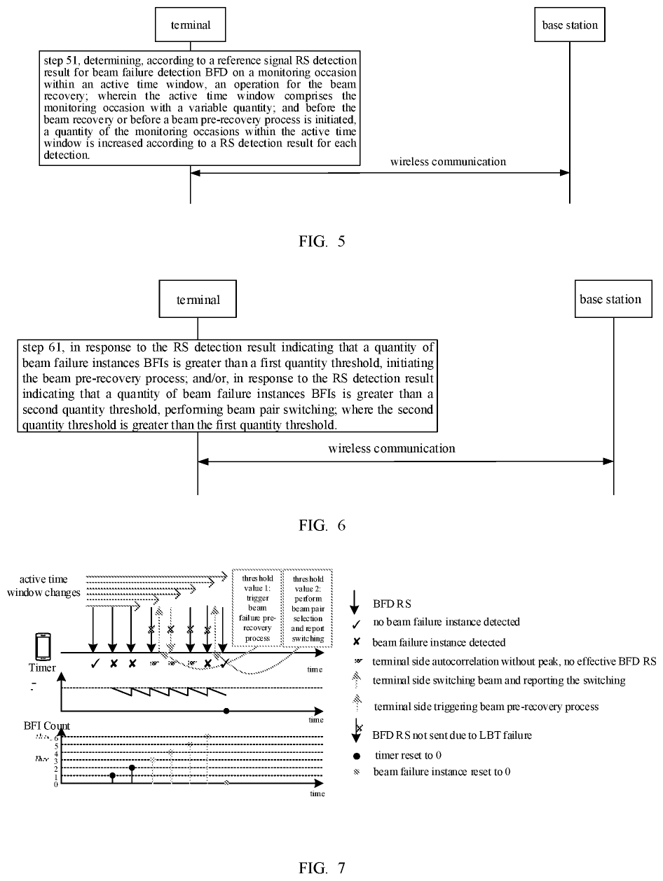

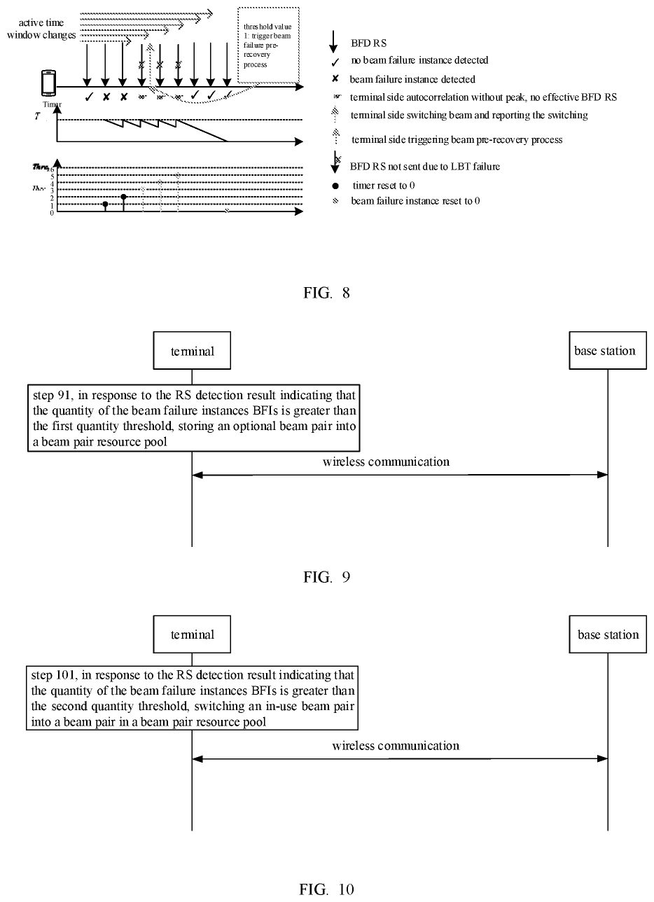

In an embodiment, as illustrated in FIG. 8, an initial value of the quantity of the monitoring occasions included in the active time window is 3. The first quantity threshold is a threshold value 1 (for example, the value is taken as 2); a RS detection result of a first BFD is that no BFI is detected; a RS detection result of a second BFD is that the BFI is detected; a RS detection result of a third BFD is that the BFI is detected, the quantity of the monitoring occasions included in the current active time window is less than the quantity of the beam failure instances required to be detected for determining whether the beam is in a beam failure state, and the quantity of the monitoring occasions included in the active time window is increased, for example, by adding a fourth monitoring occasion. During the fourth detection, the LBT failed, and a RS detection result of the fourth BFD is that the BFI is detected. Thus, since the quantity of the BFIs indicated by the RS detection results of the BFD is greater than the first quantity threshold, the terminal initiates the beam pre-recovery process.

In an embodiment, in response to that the beam pre-recovery process is initiated, the quantity of the BFIs indicated by the RS detection result of BFD is less than or equal to the second quantity threshold, and the current detection fails to detect the BFI, it is determined that the beam is in a beam recovery state.

In an embodiment, referring to FIG. 8, the second quantity threshold is a threshold value 2 (for example, the value is taken as 6). After the terminal initiates the beam pre-recovery process, the quantity of the monitoring occasions included in the active time window is continuously increased. Each RS detection result of a fifth BFD, a sixth BFD is that the BFI is detected, and a RS detection result of a seventh BFD is that no BFI is detected. Thus, since the beam recovery process is initiated, the quantity of the BFIs indicated by the RS detection results of the BFD is not greater than the second quantity threshold, and the BFI is not detected on the seventh BFD, it is determined that the beam is in the beam recovery state, and there is no requirement to perform the beam recovery, i.e., there is no requirement to perform the beam pair switching.

It should be noted that those skilled in the art may understand that the methods provided in the embodiments of the present disclosure may be performed separately or together with some methods in the embodiments of the present disclosure or the related art.

As illustrated in FIG. 9, the present embodiment provides a method for beam recovery, applied to a terminal and includes:
in step 91: in response to the RS detection result indicating that the quantity of the beam failure instances BFIs is greater than the first quantity threshold, an optional beam pair is stored into a beam pair resource pool.

In an embodiment, the terminal presets a resource pool and acquires a beam pair from the preset resource pool, where the beam pair is used for data transmission between the terminal and the base station.

In an embodiment, in response to the beam recovery is required, the terminal acquires a beam pair from a preset resource pool and performs data transmission between the terminal and the base station by using the beam pair.

In an embodiment, the base station is correspondingly preset with a resource pool. In response to that the terminal stores the optional beam pair into the beam pair resource pool, indication information indicating the beam pair is sent to the base station. After receiving the indication information, the base station stores the beam pair indicated by the indication information into the resource pool correspondingly preset by the base station. In response to the beam recovery is required, the base station acquires the beam pair from the resource pool and performs data transmission between the terminal and the base station by using the beam pair.

In an embodiment, the indication information indicates a beam pair index, with each index corresponding to a set of beam pair.

In an embodiment, in response to the RS detection result, within the active time window, indicating that the quantity of the BFIs is greater than the second quantity threshold and the base station does not receive the indication information, sent by the terminal, of the beam pair selected from the resource pool, it is determined that the current beam is in the beam recovery state. Thus, the beam pair in the resource pool may be released. Here, releasing the beam pair in the resource pool may be done by deleting the information of the beam pair in the resource pool.

In an embodiment, in response to the beam pair in the resource pool is not released, the beam pair in the resource pool may only be used for data transmission of a resource pool terminal. In response to the beam pair in the resource pool is released, the released beam may be used for data transmission of all the terminals.

In an embodiment, in response to the RS detection result, within the active time window, indicating that the quantity of the BFIs is greater than the second quantity threshold and the base station receives the indication information, sent by the terminal, of the beam pair selected from the resource pool, the current beam pair is switched to the beam pair selected from the resource pool.

In an embodiment, in response to the current beam pair is switched to the selected beam pair, the beam pair in the resource pool is released.

In an embodiment, in response to not determining that the beam is in the beam failure state, or before the beam is recovered, the beam in the resource pool is only used for data transmission of a terminal associated with the resource pool.

It should be noted that those skilled in the art may understand that the methods provided in the embodiments of the present disclosure may be performed separately or together with some methods in the embodiments of the present disclosure or the related art.

As illustrated in FIG. 10, the present embodiment provides a method for beam recovery, applied to a terminal and includes step 101:

in step 101: in response to the RS detection result indicating that the quantity of the beam failure instances BFIs is greater than the second quantity threshold, an in-use beam pair is switched into a beam pair in a beam pair resource pool.

In an embodiment, in response to the RS detection result, within the active time window, indicating that the quantity of the BFIs is greater than the second quantity threshold, the indication information of the beam pair selected from the resource pool is sent to the base station, and the current beam pair is switched to the selected beam pair.

In an embodiment, in response to the RS detection result, within the active time window, indicating that the quantity of the BFIs is greater than the second quantity threshold and the base station receives the indication information, sent by the terminal, of the beam pair selected from the resource pool, the current beam pair is switched to the selected beam pair.

In an embodiment, the terminal sends information of the quantity of the BFIs indicated by the RS detection result within the active time window to the base station.

In an embodiment, in response to the in-use beam pair is switched into the beam pair in the resource pool, the beam pair in the resource pool is released. Here, releasing the beam pair in the resource pool may be done by deleting the information of the beam pair in the resource pool.

In an embodiment, in response to not determining that the beam is in the beam failure state, or before the beam is recovered, the beam in the resource pool is only used for data transmission of a terminal associated with the resource pool.

In an embodiment, in response to the RS detection result indicating that the quantity of the beam failure instances BFIs is greater than the first quantity threshold, when the beam pair switching is performed, the optional beam pair may be stored in the beam pair resource pool; in response to the RS detection result indicating that the quantity of the beam failure instances BFIs is greater than the second quantity threshold, the in-use beam pair is switched to the beam pair in the beam pair resource pool. In this way, the efficiency of the terminal in using the beam pair may be improved.

It should be noted that those skilled in the art may understand that the methods provided in the embodiments of the present disclosure may be performed separately or together with some methods in the embodiments of the present disclosure or the related art.

As illustrated in FIG. 11, the present embodiment provides a method for beam recovery, applied to a terminal and includes step 111:

in step 111: indication information carrying a beam pair selection result for switching is sent to a base station, where a selected beam pair is a beam pair in the beam pair resource pool.

In an embodiment, the beam pair selection result is determined according to a beam quality of each beam pair in the resource pool.

In an embodiment, in response to the beam quality of the beam pair in the resource pool being greater than a quality threshold, it is determined that the beam pair is the selected beam pair. Here, the selected beam pair is the beam pair for switching. In response to the beam quality of the beam pair in the resource pool being less than a quality threshold, it is determined that the beam pair is not the selected beam pair.

In an embodiment, the beam pair selection result is determined according to a priority of each beam pair in the resource pool.

In an embodiment, in response to the priority of the beam pair in the resource pool being higher than a priority threshold, it is determined that the beam pair is the selected beam pair. In response to the priority of the beam pair in the resource pool being lower than a priority threshold, it is determined that the beam pair is not the selected beam pair.

In an embodiment, in response to that the base station receives indication information carrying the beam pair selection result for switching, the base station performs the beam switching based on the beam pair for switching indicated by the indication information.

It should be noted that those skilled in the art may understand that the methods provided in the embodiments of the present disclosure may be performed separately or together with some methods in the embodiments of the present disclosure or the related art.

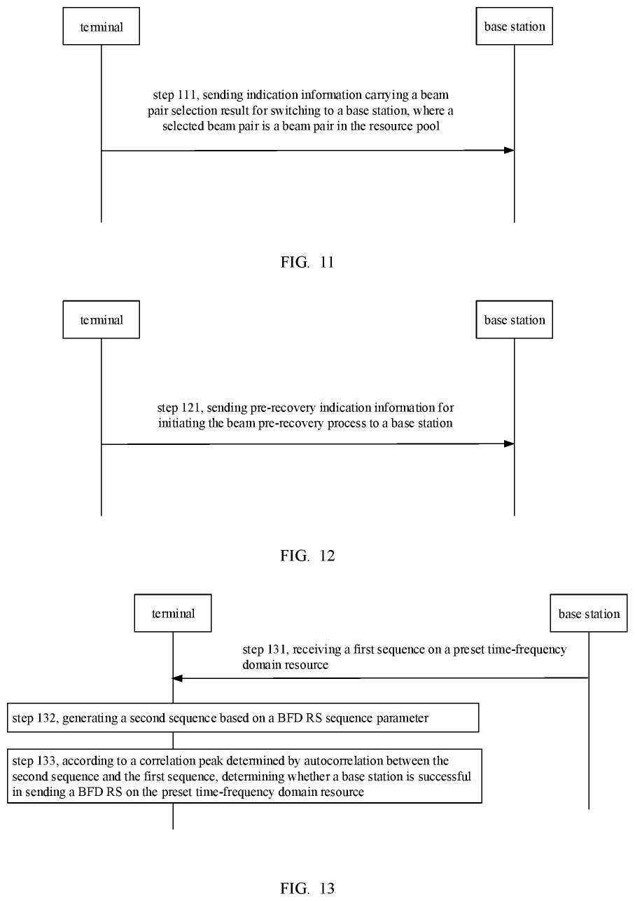

As illustrated in FIG. 12, the present embodiment provides a method for beam recovery, applied to a terminal and includes step 121:

in step 121: pre-recovery indication information for initiating the beam pre-recovery process is sent to a base station.

In an embodiment, the pre-recovery indication information may carry information of the available beam pair. Here, the information of the available beam pair may be beam information used to replace the current beam pair.

In an embodiment, the information of the available beam pair may be information of a beam pair with a quality greater than a quality threshold. In an embodiment, the information of the available beam pair may also be information of a beam pair with a priority higher than a priority threshold.

In an embodiment, in response to the beam pre-recovery process is initiated, the pre-recovery indication information for initiating the beam pre-recovery process is sent to the base station.

In an embodiment, after the pre-recovery indication information for initiating the beam pre-recovery process is sent to the base station, a response message for determining the initiation of the beam pre-recovery process is received from the base station.

It should be noted that those skilled in the art may understand that the methods provided in the embodiments of the present disclosure may be performed separately or together with some methods in the embodiments of the present disclosure or the related art.

As illustrated in FIG. 13, the present embodiment provides a method for beam recovery, applied to a terminal and includes steps 131 to 133:
in step 131: a first sequence on a preset time-frequency domain resource is received;
in step 132: a second sequence is generated based on a BFD RS sequence parameter;
in step 133: according to a correlation peak determined by autocorrelation between the second sequence and the first sequence, whether a base station is successful in sending a BFD RS on the preset time-frequency domain resource is determined.

In an embodiment, the above steps are performed before the determining the operation for the beam recovery according to the reference signal RS detection result for beam failure detection BFD on the monitoring occasion within the active time window.

In an embodiment, the terminal receives configuration information sent by the base station; where the configuration information at least indicates the preset time-frequency domain resource.

In an embodiment, the terminal receives configuration information sent by the base station; where the configuration information at least indicates the BFD RS sequence parameter.

In an embodiment, according to a size of the correlation peak, it is determined whether the base station is successful in sending the BFD RS on the preset time-frequency domain resource.

In an embodiment, in response to the correlation peak being greater than a correlation peak threshold, it is determined that the base station is successful in sending the BFD RS on the preset time-frequency domain resource; in response to the correlation peak being less than a correlation peak threshold, it is determined that the base station failed to send the BFD RS on the preset time-frequency domain resource.

In an embodiment, the RS detection result is determined according to a determination result of whether the BFD RS is successfully sent on the preset time-frequency domain resource.

In an embodiment, in response to the determining that the base station fails to send the BFD RS on the preset time-frequency domain resource, it is determined that the RS detection result indicates that a current RS detection result is a BFI; or in response to the determining that the base station is successful in sending the BFD RS on the preset time-frequency domain resource, the RS detection result is determined according to a first layer L1 reference signal received power RSRP.

In an embodiment, in response to determining the RS detection result according to the first layer L1 reference signal received power RSRP, the method further includes: in response to the RSRP being less than a RSRP threshold, it is determined that the RS detection result indicates that a current RS detection result is a BFI; or in response to the RSRP being greater than a RSRP threshold, it is determined that the RS detection result indicates that a current RS detection result is not a BFI, where the first layer may be a physical layer.

It should be noted that those skilled in the art may understand that the methods provided in the embodiments of the present disclosure may be performed separately or together with some methods in the embodiments of the present disclosure or the related art.

As illustrated in FIG. 14, the present embodiment provides a method for beam recovery, applied to a terminal and includes step 141:
in step 141: configuration information is received;
where the configuration information includes one or more of the following: information of the preset time-frequency domain resource and/or information of the BFD RS sequence parameter.

In an embodiment, in response to establishment of a wireless resource control RRC connection between the terminal and the base station, the configuration information sent by the base station is received.

In an embodiment, the configuration information sent by the base station through a random access response message is received.

In an embodiment, the terminal sends a request message for acquiring the configuration information to the base station; the terminal receives a response message, sent by the base station according to the request message, carrying the configuration information.

It should be noted that those skilled in the art may understand that the methods provided in the embodiments of the present disclosure may be performed separately or together with some methods in the embodiments of the present disclosure or the related art.

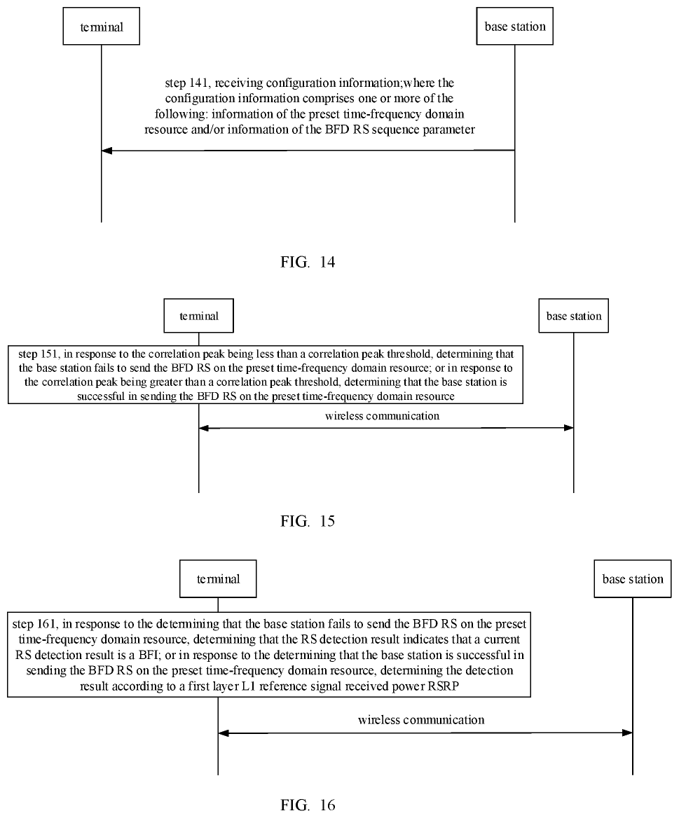

As illustrated in FIG. 15, the present embodiment provides a method for beam recovery, applied to a terminal and includes step 151:
in step 151, in response to the correlation peak being less than a correlation peak threshold, it is determined that the base station fails to send the BFD RS on the preset time-frequency domain resource;
or
in response to the correlation peak being greater than a correlation peak threshold, it is determined that the base station is successful in sending the BFD RS on the preset time-frequency domain resource.

In an embodiment, the RS detection result is determined according to a determination result of whether the BFD RS is successfully sent on the preset time-frequency domain resource.

In an embodiment, in response to the determining that the base station fails to send the BFD RS on the preset time-frequency domain resource, it is determined that the RS detection result indicates that a current RS detection result is a BFI; or in response to the determining that the base station is successful in sending the BFD RS on the preset time-frequency domain resource, the RS detection result is determined according to a first layer L1 reference signal received power RSRP.

In an embodiment, in response to determining the RS detection result according to the first layer L1 reference signal received power RSRP, the method further includes: in response to the RSRP being less than a RSRP threshold, it is determined that the RS detection result indicates that a current RS detection result is a BFI; or in response to the RSRP being greater than a RSRP threshold, it is determined that the RS detection result indicates that a current RS detection result is not a BFI, where the first layer may be a physical layer.

It should be noted that those skilled in the art may understand that the methods provided in the embodiments of the present disclosure may be performed separately or together with some methods in the embodiments of the present disclosure or the related art.

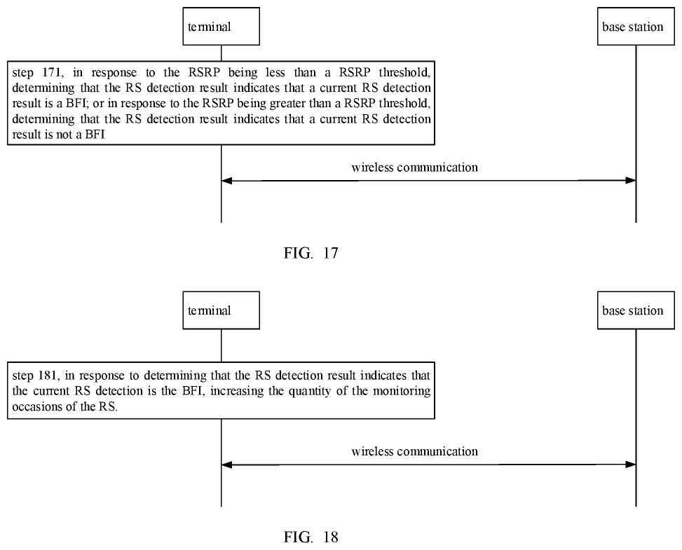

As illustrated in FIG. 16, the present embodiment provides a method for beam recovery, applied to a terminal and includes step 161:
in step 161: in response to the determining that the base station fails to send the BFD RS on the preset time-frequency domain resource, it is determined that the RS detection result indicates that a current RS detection result is a BFI; or in response to the determining that the base station is successful in sending the BFD RS on the preset time-frequency domain resource, the RS detection result is determined according to a first layer L1 reference signal received power RSRP.

In an embodiment, in response to determining the RS detection result according to the first layer L1 reference signal received power RSRP, the method further includes: in response to the RSRP being less than a RSRP threshold, it is determined that the RS detection result indicates that a current RS detection result is a BFI; or in response to the RSRP being greater than a RSRP threshold, it is determined that the RS detection result indicates that a current RS detection result is not a BFI, where the first layer may be a physical layer.

It should be noted that those skilled in the art may understand that the methods provided in the embodiments of the present disclosure may be performed separately or together with some methods in the embodiments of the present disclosure or the related art.

As illustrated in FIG. 17, the present embodiment provides a method for beam recovery, applied to a terminal and includes step 171:
in step 171, in response to the RSRP being less than a RSRP threshold, it is determined that the RS detection result indicates that a current RS detection result is a BFI; or in response to the RSRP being greater than a RSRP threshold, it is determined that the RS detection result indicates that a current RS detection result is not a BFI.

In an embodiment, in response to determining the RS detection result according to the first layer L1 reference signal received power RSRP, the method further includes: in response to the RSRP being less than a RSRP threshold, it is determined that the RS detection result indicates that a current RS detection result is a BFI; or in response to the RSRP being greater than a RSRP threshold, it is determined that the RS detection result indicates that a current RS detection result is not a BFI, where the first layer may be a physical layer.

It should be noted that those skilled in the art may understand that the methods provided in the embodiments of the present disclosure may be performed separately or together with some methods in the embodiments of the present disclosure or the related art.

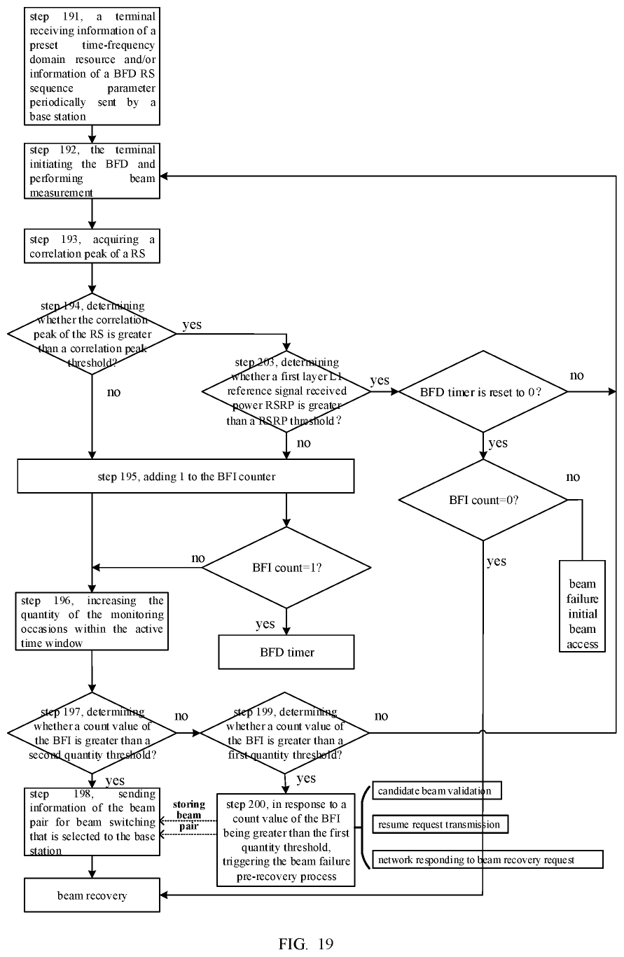

As illustrated in FIG. 18, the present embodiment provides a method for beam recovery, applied to a terminal and includes step 181:
in step 181: in response to determining that the RS detection result indicates that the current RS detection result is the BFI, the quantity of the monitoring occasions of the RS is increased.

In an embodiment, in response to the quantity of the BFIs corresponding to the RS detection result on the monitoring occasion within the active time window being less than the quantity of the beam failure instances required to be detected for determining whether the beam fails, the quantity of the monitoring occasions included in the active time window is increased.

It should be noted that those skilled in the art may understand that the methods provided in the embodiments of the present disclosure may be performed separately or together with some methods in the embodiments of the present disclosure or the related art.

In order to better understand the embodiments of the present disclosure, the embodiments of the present disclosure are further described below by way of an embodiment:

### Example 1

As illustrated in FIG. 19, the present embodiment provides a method for beam recovery, applied to a terminal and includes steps 191 to 200, 202 and 203:
in step 191: a terminal receives information of a preset time-frequency domain resource and/or information of a BFD RS sequence parameter periodically sent by a base station. The preset time-frequency domain resource and the BFD RS sequence parameter are used for that: the terminal receives the first sequence on the preset time-frequency domain resource; the terminal generates the second sequence based on the BFD RS sequence parameter; the terminal determines whether the base station is successful in sending the BFD RS on the preset time-frequency domain resource according to the correlation peak determined by the autocorrelation between the second sequence and the first sequence.
in step 192: the terminal initiates the BFD and perform beam measurement.
in step 193: a correlation peak of a RS is acquired.
in step 194: it is determined whether the correlation peak of the RS is greater than a correlation peak threshold. In response to the correlation peak being less than the correlation peak threshold, it is determined that the base station fails to send the BFD RS on the preset time-frequency domain resource, and step 195 is performed; or, in response to the correlation peak being greater than the correlation peak threshold, it is determined that the base station is successful in sending the BFD RS on the preset time-frequency domain resource, and step 203 is performed.
in step 195, the BFI counter adds 1.
in step 196: the quantity of the monitoring occasions within the active time window is increased.
in step 197: it is determined whether a count value of the BFI is greater than a second quantity threshold. In response to the count value of the BFI being greater than the second quantity threshold, step 198 is performed; otherwise step 199 is performed.
in step 198: information of the beam pair for beam switching that is selected is sent to the base station. step 202 is performed.
in step 199: it is determined whether a count value of the BFI is greater than a first quantity threshold. In response to the count value of the BFI being greater than the first quantity threshold, step 200 is performed; otherwise step 192 is performed.
in step 200: in response to a count value of the BFI being greater than the first quantity threshold, the beam pre-recovery process is triggered.
in step 202: beam recovery is performed. Here, the beam recovery includes performing the beam switching.
in step 203: it is determined whether a first layer L1 reference signal received power RSRP is greater than a RSRP threshold. In response to the RSRP being less than the RSRP threshold, step 195 is performed.

It should be noted that those skilled in the art may understand that the methods provided in the embodiments of the present disclosure may be performed separately or together with some methods in the embodiments of the present disclosure or the related art.

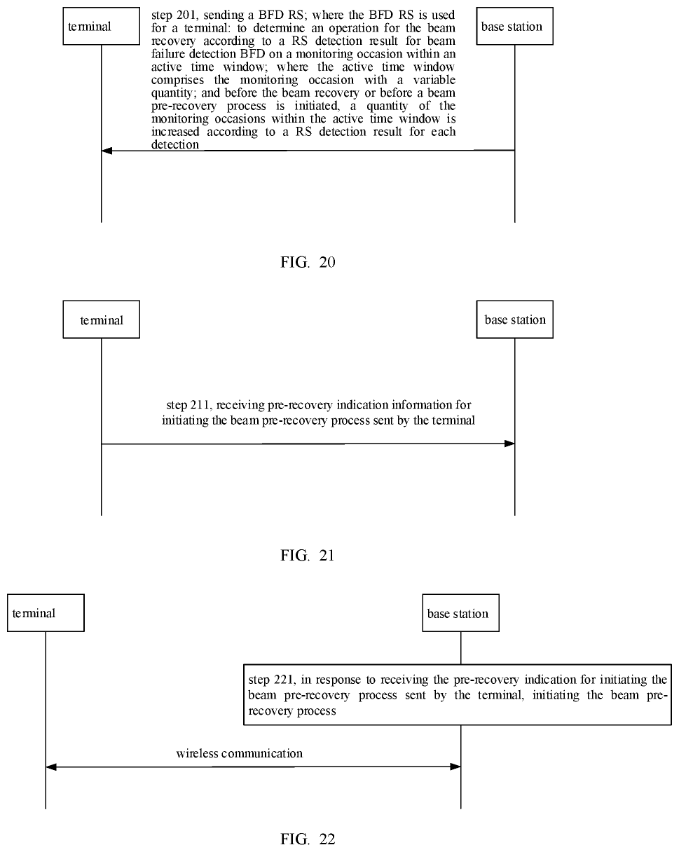

As illustrated in FIG. 20, the present embodiment provides a method for beam recovery, applied to a base station and includes step 201:
in step 201: sending a beam failure detection reference signal (BFD RS);
where the BFD RS is used for a terminal: to determine an operation for the beam recovery according to a reference signal (RS) detection result for beam failure detection (BFD) on a monitoring occasion within an active time window;
where the active time window includes the monitoring occasion with a variable quantity;
and before the beam recovery or before a beam pre-recovery process is initiated, a quantity of the monitoring occasions within the active time window is increased according to a RS detection result for each detection.

Here, the terminal may be, but is not limited to, a mobile phone, a wearable device, a vehicle terminal, a road side unit (RSU), a smart home terminal and an industrial sensing device and the like.

In an embodiment, a beam may be a beam pair for data transmission between the terminal and the base station. Here, the beam pair includes: a receiving beam for the terminal to receive data and a sending beam for the base station to send the beam.

Here, the base station may be an access device for the terminal to access a network. The base station may be various types of base stations, such as a base station of the third-generation mobile communication (3G) network, a base station of the fourth-generation mobile communication (4G) network, a base station of the fifth-generation mobile communication (5G) network, or a base station of any generation communication system.

In an embodiment, the BFD RS may be sent periodically.

In an embodiment, the beam may be a downlink beam. Here, beam failure detection may be downlink beam failure detection. The beam recovery may be downlink beam recovery.

In an embodiment, the beam recovery includes a process to perform beam access by using an available beam.

In an embodiment, in response to determining beam failure according to the RS detection result for the beam failure detection BFD on the monitoring occasion within the active time window, and if the terminal has an available beam to replace a current beam, the terminal may perform the beam access based on the available beam. If the access is successful by using the available beam, the available beam may be used to perform the data transmission between the terminal and the base station.

In some embodiments, the beam failure may occur in response to terminal movement; or, in response to network blockage, the beam failure may occur; or, in response to terminal rotation, the beam failure may occur.

In an embodiment, the active time window includes a plurality of monitoring occasions. On each monitoring occasion, the terminal performs a BFD RS detection to acquire the RS detection result for the BFD. Here, the RS detection result for the BFD may indicate a result of the beam failure.

In an embodiment, an initial quantity of the monitoring occasions included in the active time window is preset. For example, the preset active time window includes three monitoring occasions. Here, configuration information indicating the initial quantity may be received in advance from the base station.

In an embodiment, it is determined whether to increase the quantity of the monitoring occasions included in the active time window according to the RS detection result on the monitoring occasion within the active time window.

In an embodiment, in response to the quantity of the beam failure instances corresponding to the RS detection result on the monitoring occasion within the active time window being less than the quantity of the beam failure instances required to be detected for determining whether the beam fails, it is determined to increase the quantity of the monitoring occasions included in the active time window. Here, since the beam failure instances are not sufficient to determine whether the beam fails, it is necessary to continue increasing the quantity of the monitoring occasions included in the active time window and continue the BFD RS detection, so as to reduce a case of not being able to determine whether the beam fails due to insufficient quantity of the beam failure instances. In response to the quantity of the beam failure instances corresponding to the RS detection result on the monitoring occasion within the active time window being greater than or equal to the quantity of the beam failure instances required to be detected for determining whether the beam fails, it is determined not to increase the quantity of the monitoring occasions included in the active window. Here, since the beam failure instances are sufficient to determine whether the beam fails, there is no requirement to continue increasing the quantity of the monitoring occasions included in the active time window.

In an embodiment, the quantity of the beam failure instances required to be detected for determining whether the beam is in a beam failure state is n, and in response to the quantity of the monitoring occasions within the active time window being less than n, the quantity of the monitoring occasions included in the active time window may be increased; or the quantity of the beam failure instances required to be detected for determining whether the beam fails is n, and in response to the quantity of the beam failure instances detected on the monitoring occasion within the active time window is less than n, the quantity of the monitoring occasions included in the active time window may be increased.

In an embodiment, according to the beam recovery result, it is determined whether to increase the quantity of the monitoring occasions included in the active time window.

In an embodiment, in response to the beam recovery, it is determined not to increase the quantity of the monitoring occasions included in the active time window; in response to the beam being not recovered, it is determined to increase the quantity of the monitoring occasions included in the active time window.

In an embodiment, it is determined whether to increase the quantity of the monitoring occasions included in the active time window according to the initiation of a beam pre-recovery process.

In an embodiment, in response to the beam being not recovered and the beam pre-recovery process not being initiated, the quantity of the monitoring occasions included in the active time window is increased. In response to the beam pre-recovery process being initiated, the quantity of the monitoring occasions included in the active time window is increased until the beam is recovered.

In an embodiment, when the communication is performed by using the unlicensed frequency band, the active time window may correspond to a period of channel occupy time, and the beam failure instance counter is used to count the quantity of the beam failures during this period of channel occupy time. According to a count result of the beam failure instance counter within a preset time, it is determined whether the beam recovery is required. Here, one beam failure instance corresponds to one beam failure result.

In an embodiment, when the communication is performed by using the unlicensed frequency band, the active time window may also correspond to a period of non-channel occupy time, and the beam failure instance counter is used to count the quantity of the beam failures during this period of non-channel occupy time. According to a count result of the beam failure instance counter within a preset time, it is determined whether the beam recovery is required. Here, one beam failure instance corresponds to one beam failure result. Here, the non-channel occupy time may be a time that does not overlap or partially overlaps with the channel occupy time.

Here, it is determined whether the beam is in a beam failure state according to the RS detection result for the BFD.

In an embodiment, in response to a count value of a beam failure instance counter being greater than a count threshold within a preset time, the beam is in a beam failure state, it is determined that the beam recovery is required. In response to a count value of a beam failure instance counter being less than a count threshold within the preset time, there is no beam failure, it is determined that beam recovery is not required. For example, if the preset time is 3 seconds and the count threshold is 3, when the count value of the beam failure instance counter reaches 3 within 3 seconds, it is determined that beam recovery is required; when the count value of the beam failure instance counter is less than 3 within 3 seconds, it is determined that beam recovery is not required. In an embodiment, the count value of the beam failure instance counter within the preset time is a count value that counts consecutively.

In an embodiment, in response to that the beam recovery is required, the operation for the beam recovery may be to initiate the beam pre-recovery process. Here, the beam pre-recovery process may include at least one of the following: determining an available beam pair; sending a beam recovery request; receiving a response message sent by the base station according to the beam recovery request.

In an embodiment, in response to the beam recovery is required, a currently used beam may be switched to another available beam. For example, the currently used beam is a beam A, since a quality of the beam A is less than a quality threshold, the beam recovery is required, and the beam A may be switched to any of the available beams B, C, and D.

In an embodiment, in response to the beam recovery is required, the beam pre-recovery process is initiated; in response to determining the beam recovery based on the detected RS detection result for the BFD on the monitoring occasions with a set quantity after the beam pre-recovery process is initiated, there is no requirement to initiate the beam recovery process. For example, the quantity is set to 3, in response to the beam recovery is required, the beam pre-recovery process is initiated; in response to determining the beam recovery based on the detected RS detection result for the BFD on three monitoring occasions after the beam pre-recovery process is initiated, there is no requirement to initiate the beam recovery process.

In an embodiment, in response to the beam recovery is required, the beam pre-recovery process is initiated; in response to determining the beam failure again based on the detected RS detection result for the BFD on the monitoring occasions with a set quantity after the beam pre-recovery process is initiated, the beam recovery process is required to be initiated. For example, the quantity is set to 3, in response to the beam recovery is required, the beam pre-recovery process is initiated, in response to determining the beam failure based on the detected RS detection result for the BFD on three monitoring occasions after the beam pre-recovery process is initiated, the beam recovery process is required to be initiated.

In an embodiment, the beam recovery process may be a beam recovery process performed based on a result of the beam pre-recovery process. For example, the beam recovery process may be a beam recovery process performed based on an available beam determined by the beam pre-recovery process. Thus, since the beam pre-recovery process is performed in advance of the beam recovery, the beam recovery may be performed quickly when the beam recovery is required, which may improve resource utilization efficiency.

It should be noted that those skilled in the art may understand that the methods provided in the embodiments of the present disclosure may be performed separately or together with some methods in the embodiments of the present disclosure or the related art.

As illustrated in FIG. 21, the present embodiment provides a method for beam recovery, applied to a base station and includes step 211:
in step 211: pre-recovery indication information, sent by the terminal, for initiating the beam pre-recovery process is received.

In an embodiment, the pre-recovery indication information may carry information of the available beam pair. Here, the information of the available beam pair may be beam information used to replace the current beam pair.

In an embodiment, the information of the available beam pair may be information of a beam pair with a quality greater than a quality threshold. In an embodiment, the information of the available beam pair may also be information of a beam pair with a priority higher than a priority threshold.

In an embodiment, in response to the terminal initiates the beam pre-recovery process, the pre-recovery indication information for initiating the beam pre-recovery process is sent to the base station.

In an embodiment, after the base station receives the pre-recovery indication information for initiating the beam pre-recovery process, a response message for determining the initiation of the beam pre-recovery process is sent to the terminal.

It should be noted that those skilled in the art may understand that the methods provided in the embodiments of the present disclosure may be performed separately or together with some methods in the embodiments of the present disclosure or the related art.

As illustrated in FIG. 22, the present embodiment provides a method for beam recovery, applied to a base station and includes step 221:

in step 221, in response to receiving the pre-recovery indication information for initiating the beam pre-recovery process sent by the terminal, the beam pre-recovery process is initiated.

In an embodiment, the beam pre-recovery process of the terminal may include at least one of the following: determining an available beam pair; sending a beam recovery request; receiving a response message sent by the base station according to the beam recovery request.

In an embodiment, the base station initiates a beam pre-recovery process, which may be, receive the beam recovery request sent by the terminal; send the response message to the terminal according to the beam recovery request. Here, the beam recovery request carries information of the beam pair determined by the terminal.

It should be noted that those skilled in the art may understand that the methods provided in the embodiments of the present disclosure may be performed separately or together with some methods in the embodiments of the present disclosure or the related art.

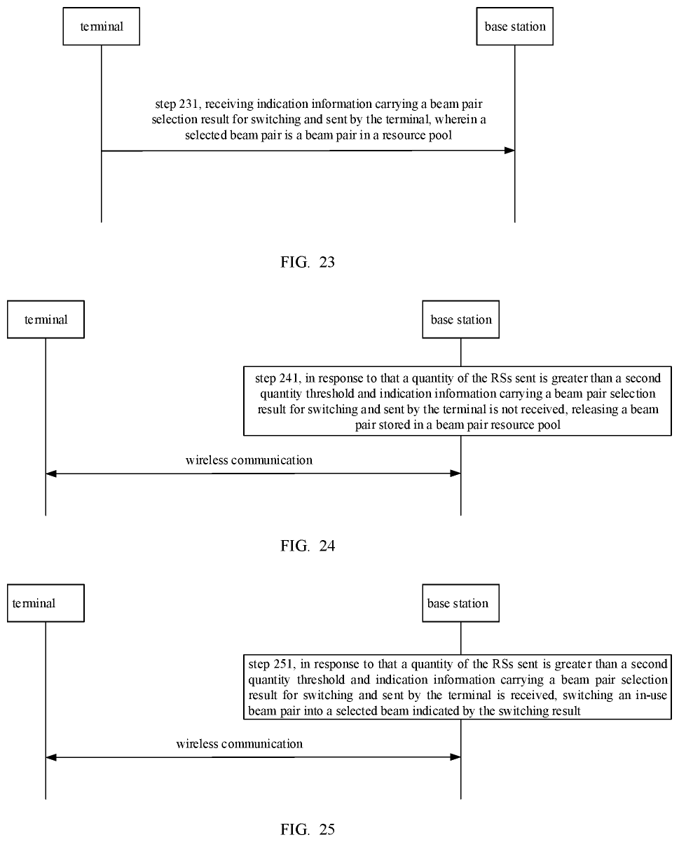

As illustrated in FIG. 23, the present embodiment provides a method for beam recovery, applied to a base station and includes step 231:
in step 231, indication information carrying a beam pair selection result for switching and sent by the terminal is received, where a selected beam pair is a beam pair in a resource pool.

In an embodiment, the beam pair selection result is determined according to a beam quality of each beam pair in the resource pool.

In an embodiment, in response to the beam quality of the beam pair in the resource pool being greater than a quality threshold, it is determined that the beam pair is the selected beam pair. Here, the selected beam pair is the beam pair for switching. In response to the beam quality of the beam pair in the resource pool being less than a quality threshold, it is determined that the beam pair is not the selected beam pair.

In an embodiment, the beam pair selection result is determined according to a priority of each beam pair in the resource pool.

In an embodiment, in response to the priority of the beam pair in the resource pool being higher than a priority threshold, it is determined that the beam pair is the selected beam pair. In response to the priority of the beam pair in the resource pool being lower than a priority threshold, it is determined that the beam pair is not the selected beam pair.

In an embodiment, in response to that the base station receives indication information carrying the beam pair selection result for switching, the base station performs the beam switching based on the beam pair for switching indicated by the indication information.

It should be noted that those skilled in the art may understand that the methods provided in the embodiments of the present disclosure may be performed separately or together with some methods in the embodiments of the present disclosure or the related art.

As illustrated in FIG. 24, the present embodiment provides a method for beam recovery, applied to a base station and includes step 241:

in step 241: in response to that a quantity of the RSs sent is greater than a second quantity threshold and indication information carrying a beam pair selection result for switching and sent by the terminal is not received, a beam pair stored in a beam pair resource pool is released.

In an embodiment, the base station presets a resource pool, and the base station acquires the beam pair from the preset resource pool for the data transmission between the terminal and the base station.

In an embodiment, in response to the beam recovery is required, the base station acquires a beam pair from a preset resource pool and performs the data transmission between the terminal and the base station by using the beam pair.

In an embodiment, in response to that the terminal stores the optional beam pair into the beam pair resource pool, indication information indicating the beam pair is sent to the base station. After receiving the indication information, the base station stores the beam pair indicated by the indication information into the resource pool correspondingly preset by the base station. In response to the beam recovery is required, the base station acquires the beam pair from the resource pool and performs data transmission between the terminal and the base station by using the beam pair.

In an embodiment, the indication information indicates a beam pair index, with each index corresponding to a set of beam pair.

In an embodiment, in response to the RS detection result, within the active time window, indicating that the quantity of the BFIs is greater than the second quantity threshold and the indication information, of the beam pair selected from the resource pool, sent by the terminal is not received, it is determined that the current beam is in the beam recovery state. Thus, the beam pair in the resource pool may be released. Here, releasing the beam pair in the resource pool may be done by deleting the information of the beam pair in the resource pool.

In an embodiment, in response to the beam pair in the resource pool is not released, the beam pair in the resource pool may only be used for data transmission of a resource pool terminal. In response to the beam pair in the resource pool is released, the released beam may be used for data transmission of all the terminals.

In an embodiment, in response to the RS detection result, within the active time window, indicating that the quantity of the BFIs is greater than the second quantity threshold and the indication information, of the beam pair selected from the resource pool, sent by the terminal is received, the current beam pair is switched to the selected beam pair.

In an embodiment, in response to the current beam pair is switched to the selected beam pair, the beam pair in the resource pool is released.

In an embodiment, in response to not determining that the beam is in the beam failure state, or before the beam is recovered, the beam in the resource pool is only used for data transmission of a terminal associated with the resource pool.

It should be noted that those skilled in the art may understand that the methods provided in the embodiments of the present disclosure may be performed separately or together with some methods in the embodiments of the present disclosure or the related art.

As illustrated in FIG. 25, the present embodiment provides a method for beam recovery, applied to a base station and includes step 251:

in step 251: in response to that a quantity of the RSs sent is greater than a second quantity threshold and indication information carrying a beam pair selection result for switching and sent by the terminal is received, an in-use beam pair is switched into a selected beam indicated by the beam pair selection result.

In an embodiment, the beam pair selection result is determined according to a beam quality of each beam pair in the resource pool.

In an embodiment, in response to the beam quality of the beam pair in the resource pool being greater than a quality threshold, the terminal determines that the beam pair is the selected beam pair. Here, the selected beam pair is the beam pair for switching. In response to the beam quality of the beam pair in the resource pool being less than a quality threshold, the terminal determines that the beam pair is not the selected beam pair.

In an embodiment, the beam pair selection result is determined according to a priority of each beam pair in the resource pool.

In an embodiment, in response to the priority of the beam pair in the resource pool being higher than a priority threshold, the terminal determines that the beam pair is the selected beam pair. In response to the priority of the beam pair in the resource pool being lower than a priority threshold, the terminal determines that the beam pair is not the selected beam pair.

In an embodiment, in response to that the base station receives indication information carrying the beam pair selection result for switching, the base station performs the beam switching based on the beam pair for switching indicated by the indication information.

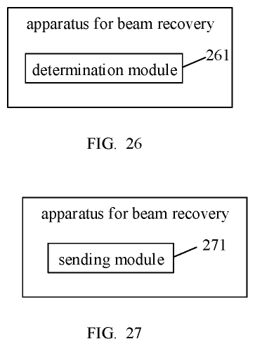

As illustrated in FIG. 26, the embodiments of the present disclosure provide an apparatus for beam recovery, where the apparatus is applied to a terminal and includes a determination module 261, where;
the determination module 261 is configured to determine, according to a reference signal RS detection result for beam failure detection BFD on a monitoring occasion within an active time window, an operation for the beam recovery;
where the active time window includes the monitoring occasion with a variable quantity;
and before the beam recovery or before a beam pre-recovery process is initiated, a quantity of the monitoring occasions within the active time window is increased according to a RS detection result for each detection.

It should be noted that those skilled in the art may understand that the methods provided in the embodiments of the present disclosure may be performed separately or together with some methods in the embodiments of the present disclosure or the related art.

As illustrated in FIG. 27, the embodiments of the present disclosure provide an apparatus for beam recovery, where the apparatus is applied to a base station and includes a sending module 271; where,
the sending module 271 is configured to send a BFD RS;
where the BFD RS is used for a terminal to determine an operation for the beam recovery according to a RS detection result for beam failure detection BFD on a monitoring occasion within an active time window;
where the active time window includes the monitoring occasion with a variable quantity;
and before the beam recovery or before a beam pre-recovery process is initiated, a quantity of the monitoring occasions within the active time window is increased according to a RS detection result for each detection.

With regard to the device in the above-mentioned embodiment, the specific manner in which the respective modules perform their operations has been described in detail in the embodiment concerning the method and will not be described in detail here.

The embodiments of the present disclosure provide a communication device, including:
a processor; and
a memory for storing executable instructions of the processor,
where the processor is configured to implement the method according to any embodiment of the present disclosure when running the executable instructions.

The processor may include various types of storage media, the storage media is non-transitory computer storage media that are capable of continuing to store information after the communication device has been powered down.

The processor may be connected to the memory via a bus, and the like, for reading executable programs stored on the memory.

The embodiments of the present disclosure provide a computer storage medium having a computer executable program stored thereon that, when being executed by the processor, implements the method according to any embodiment of the present disclosure.

With regard to the device in the above-mentioned embodiment, the specific manner in which the respective modules perform their operations has been described in detail in the embodiment concerning the method and will not be described in detail here.

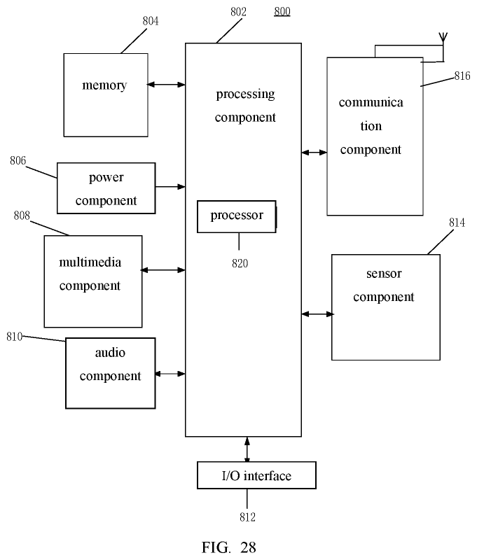

As shown in FIG. 28, an embodiment of the present disclosure provides a structure of a terminal.

Referring to FIG. 28, an embodiment provides a terminal 80. The terminal may be a mobile phone, a computer, a digital broadcasting terminal, a messaging device, a game console, a tablet device, a medical device, a fitness device, a personal digital assistant, or the like.

Referring to FIG. 28, the terminal 800 may include one or more of a processing component 802, a memory 804, a power component 806, a multimedia component 808, an audio component 810, an input/output (I/O) interface 812, a sensor component 814, and a communication component 816.

The processing component 802 generally controls the overall operations of the terminal 800, such as operations associated with display, telephone calls, data communications, camera operations, and recording operations. The processing component 802 may include one or more processors 820 to execute instructions to complete all or part of the steps of the foregoing method. In addition, the processing component 802 may include one or more modules to facilitate interaction between the processing component 802 and other components. For example, the processing component 802 may include a multimedia module to facilitate the interaction between the multimedia component 808 and the processing component 802.

The memory 804 is configured to store various types of data to support the operation at the device 800. Examples of these data include instructions for any application or method operating on the terminal 800, contact data, phone book data, messages, pictures, videos and the like. The memory 804 may be implemented by any type of volatile or non-volatile storage device or a combination thereof, such as static random access memory (SRAM), electrically erasable programmable read-only memory (EEPROM), erasable and programmable read-only memory (EPROM), programmable read-only memory (PROM), read-only memory (ROM), magnetic memory, flash memory, magnetic disk or optical disk.

The power component 806 provides power to various components of the terminal 800. The power component 806 may include a power management system, one or more power supplies, and other components associated with generating, managing, and distributing power for the terminal 800.

The multimedia component 808 includes a screen that provides an output interface between the terminal 800 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, sliding, and gestures on the touch panel. The touch sensor may not only sense the boundary of the touch or slide action, but also detect the duration and pressure related to the touch or slide operation. In some embodiments, the multimedia component 808 includes a front camera and/or a rear camera. When the device 800 is in an operation mode, such as a shooting mode or a video mode, the front camera and/or the rear camera can receive external multimedia data. Each front camera and rear camera may be a fixed optical lens system or have focal length and optical zoom capabilities.

The audio component 810 is configured to output and/or input audio signals. For example, the audio component 810 includes a microphone (MIC), and when the terminal 800 is in an operation mode, such as a call mode, a recording mode, and a voice recognition mode, the microphone is configured to receive an external audio signal. The received audio signal can be further stored in the memory 804 or sent via the communication component 816. In some embodiments, the audio component 810 further includes a speaker for outputting audio signals.

The I/O interface 812 provides an interface between the processing component 802 and a peripheral interface module. The above-mentioned peripheral interface module may be a keyboard, a click wheel, a button, and the like. These buttons may include but are not limited to home button, volume button, start button, and lock button.

The sensor component 814 includes one or more sensors for providing the terminal 800 with various aspects of state evaluation. For example, the sensor component 814 can detect the on/off status of the terminal 800 and the relative positioning of components. For example, the component is a display and keypad of the terminal 800. The sensor component 814 can also detect the position change of the terminal 800 or a component of the terminal 800, the presence or absence of contact between the user and the terminal 800, the orientation or acceleration/deceleration of the terminal 800, and the temperature change of the terminal 800. The sensor component 814 may include a proximity sensor configured to detect the presence of nearby objects when there is no physical contact. The sensor component 814 may also include a light sensor, such as a CMOS or CCD image sensor, for use in imaging applications. In some embodiments, the sensor component 814 may also include an acceleration sensor, a gyroscope sensor, a magnetic sensor, a pressure sensor, or a temperature sensor.

The communication component 816 is configured to facilitate wired or wireless communication between the terminal 800 and other devices. The terminal 800 can access a wireless network based on a communication standard, such as WiFi, 2G, or 3G, or a combination thereof. In an embodiment, the communication component 816 receives a broadcast signal or broadcast related information from an external broadcast management system via a broadcast channel. In an embodiment, the communication component 816 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an embodiment, the terminal 800 may be implemented by one or more of application specific integrated circuit (ASIC), digital signal processor (DSP), digital signal processing device (DSPD), programmable logic devices (PLD), field programmable gate array (FPGA), controller, microcontroller, microprocessor, or other electronic components, to perform the above-mentioned methods.

An embodiment also provides a non-transitory computer-readable storage medium including instructions, such as the memory 804 including instructions, and the instructions may be executed by the processor 820 of the terminal 800 to complete the foregoing method. For example, the non-transitory computer-readable storage medium may be ROM, random access memory (RAM), CD-ROM, magnetic tape, floppy disk, optical data storage device and the like.

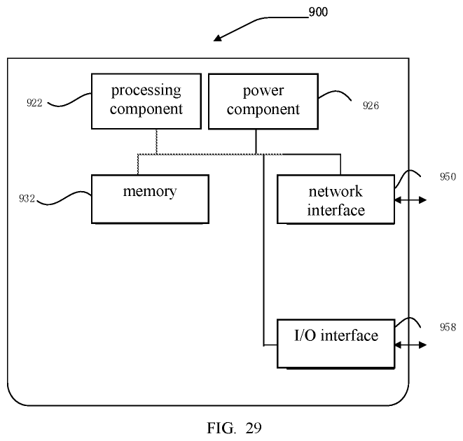

As shown in FIG. 29, an embodiment of the present disclosure provides a structure of a base station. For example, the base station 900 may be provided as a device at the network side. Referring to FIG. 29, the base station 900 includes a processing component 922 which further includes one or more processors, and a memory resource which is represented by a memory 932 and is configured for storing instructions such as application programs executable by the processing component 922. The application program stored in the memory 932 may include one or more modules each corresponding to a set of instructions. Furthermore, the processing component 922 is configured to execute instructions to perform any one of the above methods applied to the base station.

The base station 900 may also include a power component 926 configured to perform power management of the base station 900, a wired or wireless network interface 950 configured to connect the base station 900 to a network, and an input/output (I/O) interface 958. The base station 900 may operate based on an operating system stored in memory 932, such as Windows Server™, Mac OS X™, Unix™, Linux™, Free BSD™ or the like.

According to a first aspect of the present embodiments, the method for beam recovery is provided, applied to a terminal, and the method includes:
determining, according to a reference signal RS detection result for beam failure detection BFD on a monitoring occasion within an active time window, an operation for the beam recovery;
where the active time window includes the monitoring occasion with a variable quantity; and before the beam recovery or before a beam pre-recovery process is initiated, a quantity of the monitoring occasions within the active time window is increased according to a RS detection result for each detection.

In an embodiment, the determining the operation for the beam recovery according to the RS detection result for the BFD on the monitoring occasion within the active time window includes:
initiating, in response to the RS detection result indicating that a quantity of beam failure instances BFIs is greater than a first quantity threshold, the beam pre-recovery process;
and/or,
performing, in response to the RS detection result indicating that a quantity of beam failure instances BFIs is greater than a second quantity threshold, beam pair switching; where the second quantity threshold is greater than the first quantity threshold.

In an embodiment, the initiating the beam pre-recovery process further includes:
storing, in response to the RS detection result indicating that the quantity of the beam failure instances BFIs is greater than the first quantity threshold, an optional beam pair into a beam pair resource pool.

In an embodiment, the performing the beam pair switching in response to the RS detection result indicating that the quantity of the beam failure instances BFIs is greater than the second quantity threshold includes:

switching, in response to the RS detection result indicating that the quantity of the beam failure instances BFIs is greater than the second quantity threshold, an in-use beam pair into a beam pair in a beam pair resource pool.

In an embodiment, in response to the performing the beam pair switching, the method further includes:
sending indication information carrying a beam pair selection result for switching to a base station, where a selected beam pair is a beam pair in the resource pool.

In an embodiment, the initiating the beam pre-recovery process includes:
sending pre-recovery indication information for initiating the beam pre-recovery process to a base station.

In an embodiment, before the determining the operation for the beam recovery according to the reference signal RS detection result for the beam failure detection BFD on the monitoring occasion within the active time window, the method further includes:
receiving a first sequence on a preset time-frequency domain resource;
generating a second sequence based on a BFD RS sequence parameter; and
determining, according to a correlation peak determined by autocorrelation between the second sequence and the first sequence, whether a base station is successful in sending a BFD RS on the preset time-frequency domain resource.

In an embodiment, the method further includes:
receiving configuration information;
where the configuration information includes one or more of the following: information of the preset time-frequency domain resource and/or information of the BFD RS sequence parameter.

In an embodiment, the determining whether the base station is successful in sending the BFD RS on the preset time-frequency domain resource according to the correlation peak determined by the autocorrelation between the second sequence and the first sequence includes:
determining, in response to the correlation peak being less than a correlation peak threshold, that the base station fails to send the BFD RS on the preset time-frequency domain resource;
or
determining, in response to the correlation peak being greater than a correlation peak threshold, that the base station is successful in sending the BFD RS on the preset time-frequency domain resource.

In an embodiment, the method further includes:
determining, in response to the determining that the base station fails to send the BFD RS on the preset time-frequency domain resource, that the RS detection result indicates that a current RS detection result is a BFI;
or,
determining, in response to the determining that the base station is successful in sending the BFD RS on the preset time-frequency domain resource, the detection result according to a first layer L1 reference signal received power RSRP.

In an embodiment, the determining the detection result according to the first layer L1 reference signal received power RSRP includes:
determining, in response to the RSRP being less than a RSRP threshold, that the RS detection indicates that a current RS detection result is a BFI;
or,
determining, in response to the RSRP being greater than a RSRP threshold, that the RS detection result indicates that a current RS detection result is not a BFI.

In an embodiment, the method further includes:
increasing, in response to determining that the RS detection result indicates that the current RS detection result is the BFI, the quantity of the monitoring occasions of the RS.

According to a second aspect of the present embodiments, the method for beam recovery is provided, applied to a base station, and the method includes:
sending a BFD RS;
where the BFD RS is used for a terminal: to determine an operation for the beam recovery according to a RS detection result for beam failure detection BFD on a monitoring occasion within an active time window;
where the active time window includes the monitoring occasion with a variable quantity;
and before the beam recovery or before a beam pre-recovery process is initiated, a quantity of the monitoring occasions within the active time window is increased according to a RS detection result for each detection.

In an embodiment, the method further includes:
receiving pre-recovery indication information for initiating the beam pre-recovery process, where the pre-recovery indication information is sent by the terminal.

In an embodiment, the method further includes:
initiating, in response to receiving the pre-recovery indication information for initiating the beam pre-recovery process sent by the terminal, the beam pre-recovery process.

In an embodiment, the method further includes:
receiving indication information carrying a beam pair selection result for switching and sent by the terminal, where a selected beam pair is a beam pair in a resource pool.

In an embodiment, the method further includes:
releasing, in response to that a quantity of the RSs sent is greater than a second quantity threshold and indication information carrying a beam pair selection result for switching and sent by the terminal is not received, a beam pair stored in a beam pair resource pool.

In an embodiment, the method further includes:
switching, in response to that a quantity of the RSs sent is greater than a second quantity threshold and indication information carrying a beam pair selection result for switching and sent by the terminal is received, an in-use beam pair into a selected beam indicated by the beam pair selection result.

According to a third aspect of the present embodiments, the apparatus for beam recovery is provided, applied to a terminal, and the apparatus includes a determination module, where
the determination module is configured to determine, according to a reference signal RS detection result for beam failure detection BFD on a monitoring occasion within an active time window, an operation for the beam recovery;
where the active time window includes the monitoring occasion with a variable quantity; and before the beam recovery or before a beam pre-recovery process is initiated, a quantity of the monitoring occasions within the active time window is increased according to a RS detection result for each detection.

According to a fourth aspect of the present embodiments, the apparatus for beam recovery is provided, applied to a base station, and the apparatus includes a sending module, where
the sending module is configured to send a BFD RS;
where the BFD RS is used for a terminal to determine an operation for the beam recovery according to a RS detection result for beam failure detection BFD on a monitoring occasion within an active time window;
where the active time window includes the monitoring occasion with a variable quantity; and before the beam recovery or before a beam pre-recovery process is initiated, a quantity of the monitoring occasions within the active time window is increased according to a RS detection result for each detection.

According to a fifth aspect of the present embodiments, a communication device is provided and includes:
a processor; and
a memory for storing executable instructions of the processor,
where the processor is configured to implement the method according to any embodiment of the present disclosure when running the executable instructions.

According to a sixth aspect of the present embodiments, a computer storage medium is provided, the computer storage medium has a computer executable program stored thereon that, when being executed by the processor, implements the method according to any embodiment of the present disclosure.

In the embodiment of the present disclosure, the operation for the beam recovery is determined according to the RS detection result for the BFD on the monitoring occasion within the active time window. Here, since the active time window includes the monitoring occasion with a variable quantity; before the beam recovery or before the beam pre-recovery process is initiated, a quantity of the monitoring occasions within the active time window may be increased according to the RS detection result for each detection. The BFD is performed on the monitoring occasion within the active time window, compared to a case in which the RS detection result for the BFD cannot be determined outside a range of the channel occupy time or a case in which the RS detection result for the BFD cannot be determined before relevant information about the channel occupy time is received, this solution may accurately acquire the RS detection result for the BFD based on the monitoring occasion within the active time window, so as to perform the operation for the beam recovery.

Those skilled in the art may easily conceive of other embodiments of the present disclosure upon consideration of the specification and practice of the invention disclosed herein. The present disclosure is intended to cover any variations, uses, or adaptations of the present disclosure that follow the general principles of the present disclosure and include the common general knowledge or conventional technical means in the technical field not disclosed by the present disclosure. The specification and embodiments are to be regarded as exemplary only, with the true scope and spirit of the present disclosure being indicated by the following claims.

It is to be understood that the present disclosure is not limited to the precise structures described above and illustrated in the accompanying drawings, and that various modifications and changes may be made without departing from the scope thereof. The scope of the present disclosure is limited only by the appended claims.

1. A method for beam recovery, performed by a terminal, comprising:
determining, according to a reference signal (RS) detection result for beam failure detection (BFD) on a monitoring occasion within an active time window, an operation for the beam recovery;
wherein the active time window comprises the monitoring occasion with a variable quantity; and before the beam recovery or before a beam pre-recovery process is initiated, a quantity of the monitoring occasions within the active time window is increased according to a RS detection result for each BFD.

2. The method according to claim 1, wherein determining the operation for the beam recovery according to the RS detection result for the BFD on the monitoring occasion within the active time window comprises at least one of following acts:
determining the RS detection result indicating that a quantity of beam failure instances (BFIs) is greater than a first quantity threshold, and initiating the beam pre-recovery process; or,
determining the RS detection result indicating that a quantity of beam failure instances (BFIs) is greater than a second quantity threshold, and performing beam pair switching; wherein the second quantity threshold is greater than the first quantity threshold.

3. The method according to claim 2, wherein initiating the beam pre-recovery process further comprises:
determining the RS detection result indicating that the quantity of the BFIs is greater than the first quantity threshold, and storing an optional beam pair into a beam pair resource pool.

4. The method according to claim 1, wherein determining the operation for the beam recovery according to the RS detection result for the BFD on the monitoring occasion within the active time window comprises:
determining the RS detection result indicating that a quantity of beam failure instances (BFIs) is greater than a second quantity threshold, and performing beam pair switching;
wherein determining the RS detection result indicating that the quantity of the BFIs is greater than the second quantity threshold and performing the beam pair switching comprises:
determining the RS detection result indicating that the quantity of the BFIs is greater than the second quantity threshold, switching an in-use beam pair into a beam pair in a beam pair resource pool.

5. The method according to claim 4, further comprising:
sending indication information carrying a beam pair selection result for switching to a base station, wherein a selected beam pair is a beam pair in the beam pair resource pool.

6. The method according to claim 2, wherein initiating the beam pre-recovery process comprises:
sending pre-recovery indication information for initiating the beam pre-recovery process to a base station.

7. The method according to claim 2, further comprising:
receiving a first sequence on a preset time-frequency domain resource;
generating a second sequence based on a BFD RS sequence parameter; and
determining, according to a correlation peak determined by autocorrelation between the second sequence and the first sequence, whether a base station is successful in sending a BFD RS on the preset time-frequency domain resource.

8. The method according to claim 7, further comprising:
receiving configuration information;
wherein the configuration information comprises at least one of following:
information of the preset time-frequency domain resource or information of the BFD RS sequence parameter.

9. The method according to claim 7, wherein determining whether the base station is successful in sending the BFD RS on the preset time-frequency domain resource according to the correlation peak comprises:
determining the correlation peak being less than a correlation peak threshold, and determining that the base station fails to send the BFD RS on the preset time-frequency domain resource; or
determining the correlation peak being greater than a correlation peak threshold, and determining that the base station is successful in sending the BFD RS on the preset time-frequency domain resource.

10. The method according to claim 9, further comprising:
determining that the base station fails to send the BFD RS on the preset time-frequency domain resource, and determining that the RS detection result indicates that a current RS detection result is a BFI; or,
determining that the base station is successful in sending the BFD RS on the preset time-frequency domain resource, and determining the RS detection result according to a first layer (L1) reference signal received power (RSRP).

11. The method according to claim 10, wherein determining the RS detection result according to the first layer (L1) reference signal received power (RSRP) comprises:
determining the RSRP being less than a RSRP threshold, and determining that the RS detection result indicates that a current RS detection result is a BFI; or,
determining the RSRP being greater than a RSRP threshold, and determining that the RS detection result indicates that a current RS detection result is not a BFI.

12. The method according to claim 11, further comprising:
determining that the RS detection result indicates that the current RS detection result is the BFI, and increasing the quantity of the monitoring occasions of the RS.

13. A method for beam recovery, performed by a base station, comprising:
sending a beam failure detection reference signal (BFD RS);
wherein the BFD RS is used for a terminal to determine an operation for the beam recovery according to a reference signal (RS) detection result for beam failure detection (BFD) on a monitoring occasion within an active time window;
wherein the active time window comprises the monitoring occasion with a variable quantity; and before the beam recovery or before a beam pre-recovery process is initiated, a quantity of the monitoring occasions within the active time window is increased according to a RS detection result for each BFD.

14. The method according to claim 13, further comprising:
receiving pre-recovery indication information for initiating the beam pre-recovery process, wherein the pre-recovery indication information is sent by the terminal.

15. The method according to claim 14, further comprising:
receiving the pre-recovery indication information, and initiating the beam pre-recovery process.

16. The method according to claim 13, further comprising:
receiving indication information carrying a beam pair selection result for switching and sent by the terminal, wherein a selected beam pair is a beam pair in a beam pair resource pool.

17. The method according to claim 13, further comprising:
determining that a quantity of the RSs sent is greater than a second quantity threshold and indication information carrying a beam pair selection result for switching and sent by the terminal is not received, and releasing a beam pair stored in a beam pair resource pool.

18. The method according to claim 13, further comprising:
determining that a quantity of the RSs sent is greater than a second quantity threshold and indication information carrying a beam pair selection result for switching and sent by the terminal is received, and switching an in-use beam pair into a selected beam indicated by the beam pair selection result.

19-20. (canceled)

21. A communication device, comprising:
a processor; and
a memory for storing executable instructions of the processor;
wherein when running the executable instructions, the processor is configured to:
determine, according to a reference signal (RS) detection result for beam failure detection (BFD) on a monitoring occasion within an active time window, an operation for the beam recovery;
wherein the active time window comprises the monitoring occasion with a variable quantity; and before the beam recovery or before a beam pre-recovery process is initiated, a quantity of the monitoring occasions within the active time window is increased according to a RS detection result for each BFD.

22. (canceled)

23. A communication device, comprising:
a processor; and
a memory for storing executable instructions of the processor;
wherein when running the executable instructions, the processor is configured to implement the method according to claim 13.
